(19) United States
(12) Patent Application Publication
(10) Pub. No.: US 2019/0292489 A1
(43) Pub. Date: Sep. 26, 2019

(54) FLOATING CANDLE

(71) Applicant: Ho Seung JEUN, Pohang-si (KR)

(72) Inventor: Ho Seung JEUN, Pohang-si (KR)

(21) Appl. No.: 16/305,977

(22) PCT Filed: Jun. 21, 2017
(86) PCT No.: PCT/KR2017/006469

§ 371 Date: Nov. 30, 2018

(30) Foreign Application Priority Data
Jul. 8, 2016 (KR) 10-2016-0086758
Jan. 5, 2017 (KR) 10-2017-0001907

(51) Int. Cl. C11C 5/00; F21V 35/00; F23D 3/24; F21V 37/00

(52) U.S. Cl. CPC C11C 5/008; C11C 5/006; F21V 37/0004; F23D 3/24; F21V 35/003

(57) ABSTRACT

The present invention relates to a floating candle. A floating candle according to a first embodiment of the present invention includes: a floating part (100) configured to float on combustible material (W); a wick reception part (200) configured such that one side thereof passes through the floating part (100) and comes into contact with the combustible material (W) and the other side thereof comes into contact with the top surface of the floating part (100); and a wick support part (300) configured to be mounted at the bottom end of a wick (S), to be inserted into the wick reception part (200), and to support the wick (S). According to the present invention, the heat of flames can be transferred to the combustion material (W) and rapidly melts the combustion material (W), thereby enabling the perfume of perfumed oil contained in the combustion material to be rapidly emitted.

### TECHNICAL FIELD

The present invention relates to a floating candle, and more specifically to a floating candle in which the heat of the flames of a wick is transferred to solid-state combustible material through thermal conduction and melts the combustible material within a short period of time and which can continuously burn the combustible material while floating on the melted combustible material.

### BACKGROUND ART

Candles are used for the lighting purpose of lighting surroundings during a power failure, and are widely used in ceremonies, such as religious ceremonies or wedding ceremonies, or in ancestral rites in homes. Generally, candles are each configured in such a manner that a combustible solid, such as paraffin lead, i.e., a type of wax, or bees wax, is melted at a predetermined temperature and molded into a cylindrical shape or the like and a wick made of cotton or the like is inserted into the center of the combustible solid.

Furthermore, candles are each used in a state in which a wick protruding from the top thereof has been lit. Wax near the wick is melted due to the temperature of the flames of the lit wick and moved up the wick due to a capillary phenomenon, and thus the candle is continuously burned. Furthermore, the ornament of the appearance or size of candles varies depending on the nature of an event. In particular, when candles are used in an event, such as a wedding ceremony or party, richly ornamented and largely molded candles are used.

Such conventional candles are each fabricated using a method of fastening a wick to a cup, introducing melted wax into the cup, and solidifying the wax. Accordingly, the conventional candles undergo the steps of fastening a wick to a cup and waiting until the wax is solidified during fabrication, and thus inconvenience arises in that a fabrication process is cumbersome.

Furthermore, the conventional candles are problematic in that the service life spans thereof are limited because they can be used until wax connected to wicks is available.

Furthermore, the conventional candles are problematic in that the risk of a fire attributable to the burning of wax itself is significantly high when the candles fall over because there is no separate safety device between combustible wax and lit wicks.

Moreover, the conventional candles are problematic in that it is difficult for them to produce a new aesthetic because they are molded into predetermined basic shapes.

### PRIOR ART DOCUMENT

Korean Registered Utility Model No. 20-0394789 (Mar. 2, 20009)

### DISCLOSURE

### Technical Problem

The present invention has been conceived to overcome the above-described problems, and an object of the present invention is to provide a floating candle in which the heat of the flames of a wick is transferred to solid-state combustible material through thermal conduction without directly coming into contact with the combustible material and melts the combustible material within a short period of time, thereby enabling perfumed oil, contained in the solid-state combustible material, to rapidly emit perfume.

Another object of the present invention is to solve the problem in which during burning, a wick support part and a floating part configured to float a conduction part are thermally damaged by the application of excessive heat thereto, or a floating candle is overturned while moving to the periphery of a container due to the surface tension between the floating part and the container containing combustible material, thereby causing a fire.

### Technical Solution

A floating candle according to a first embodiment of the present invention includes: a floating part (100) configured to float on combustible material (W); a wick reception part (200) configured such that one side thereof passes through the floating part (100) and comes into contact with the combustible material (W) and the other side thereof comes into contact with the top surface of the floating part (100); and a wick support part (300) configured to be mounted at the bottom end of a wick (S), to be inserted into the wick reception part (200), and to support the wick (S).

The floating part (100) may include: a floating part body (110) configured such that a space (111-1) is formed therein; a first through hole (120) formed from the top surface of the floating part body 110 to the bottom surface thereof so that the wick reception part (200) can be inserted thereinto; combustible material flow paths (130) formed in the lower portion of the floating part body (110) in order to make the outside of the floating part body (110) and the first through hole (120) communicate with each other; support portions (140) configured to protrude from the inside surface of the first through hole (120) and to support the bottom end of the wick reception part (200); and protruding portions (150) configured to protrude from the side surfaces of the floating part body (110).

The floating part body (110) may include: a space formation part (111) configured such that the space 111-1 is formed therein and the combustible material flow paths (130) are formed in a lower portion thereof; and a cover part (113) configured to be coupled to the top surface of the space formation part (111).

The space formation part (111) and the cover part (113) may be sealed and integrated with each other.

The floating part body (110) may further include: an ornamentation part (112) configured to be disposed between the space formation part (111) and the cover part (113).

The wick reception part (200) may include: an upper plate (210) configured to come into contact with the top surface of the floating part (100); a second through hole (220) formed from the top surface of the upper plate (210) to the bottom surface thereof; a conduction part (230) extended upward or downward from the inner circumferential surface of the second through hole (220); and support protrusions (240) configured to protrude from the upper plate (210) or conduction part (230), to come into contact with the support portions (140), and to support the bottom end of the wick reception part (200).

The wick reception part (200) may include: gaps (250) formed to space the upper plate (210) and the conduction part (230) apart from each other by a predetermined interval; connection portions (260) configured to traverse the gaps (250) and connect the upper plate (210) and the conduction part (230) to each other; and stop plates (231) configured to protrude inward from the inner circumferential surface of the conduction part (230).

The upper plate (210) may include: ornamental holes (211) formed in a vertical direction.

The wick support part (300) may include: a wick support part bottom surface (310) configured to support the bottom surface of the wick (S), and formed in the same shape as the second through hole (220); wick support part side surfaces (320) extended from both sides of the wick support part bottom surface (310), and configured to support the side surfaces of the wick (S); and first fastening protrusions 330 configured to protrude from the wick support part side surface (320), and to fasten the wick (S).

In a second embodiment of the present invention, the wick reception part (200) may include: a closing part (270) configured to protrude from the inner circumferential surface of the conduction part (230) in order to close the second through hole (220); and third through holes (280) configured to pass through the closing part (270) in a vertical direction in order to allow the combustible material (W) to come into contact with the wick.

The wick reception part (200) may further include: a second conduction part (290) formed to be spaced apart from the inner circumferential surface of the conduction part (230) by a predetermined distance, and to protrude upward from the closing part (270).

The wick support part (300) may include: a third conduction part (310′) formed to come into contact with the outside surface of the second conduction part (290); and wick fastening parts (320′) each configured such that one end thereof is fastened to the bottom end of the third conduction part (310′) and the other end thereof is formed to be parallel to the side surface of the third conduction part (310′).

The wick support part (300) may further include: second fastening protrusions (330′) formed to protrude from the wick fastening parts (320′) toward the third conduction part (310′).

### Advantageous Effects

As described above, according to the present invention, the fabrication of a candle can be completed by disposing the floating candle on the combustible material contained in a container having a predetermined shape, thereby improving the efficiency of the fabrication of a candle.

Furthermore, the combustible material can be effectively melted within a short period of time by rapidly transferring the heat of flames to the combustible material. Accordingly, when perfume is contained in the combustible material, the perfume can be rapidly emitted.

Furthermore, the floating candle can be prevented from sinking or being inclined by preventing the floating part body from being thermally damaged, thereby reducing the risk of a fire attributable to contact between the combustible material and a flame.

Furthermore, when the combustible material is all exhausted, the floating candle can be moved to combustible material contained in another container and be continuously used, thereby enabling semi-permanent use.

Furthermore, components, such as the floating part, etc., are disposed between the wick and the combustible material, thereby preventing the flames of the wick from coming into direct contact with the combustible material. Accordingly, the risk of a fire attributable to the burning of wax itself can be reduced.

Moreover, the shapes of the wick reception part, the floating part, and the ornamentation part located in the floating part can be formed in various manners, and the floating candle can move while floating on the combustible material, thereby producing a new aesthetic to a viewer.

### DESCRIPTION OF DRAWINGS

FIG. 1 is a perspective view of a floating candle according to a first embodiment of the present invention;

FIG. 2 is a plan view of the floating candle according to the first embodiment of the present invention;

FIG. 3 is an exploded view of the floating candle according to the first embodiment of the present invention.

FIG. 4 is a perspective view of a floating part in the floating candle according to the first embodiment of the present invention;

FIG. 5 is a plan view of the floating part in the floating candle according to the first embodiment of the present invention;

FIG. 6 is an exploded view of the floating part in the floating candle according to the first embodiment of the present invention;

FIG. 7 is a perspective view of a wick reception part in the floating candle according to the first embodiment of the present invention;

FIG. 8 is a plan view of the wick reception part in the floating candle according to the first embodiment of the present invention;

FIG. 9 is a bottom perspective view of the wick reception part in the floating candle according to the first embodiment of the present invention;

FIG. 10 is a perspective view of a floating candle according to a second embodiment of the present invention;

FIG. 11 is a plan view of the floating candle according to the second embodiment of the present invention;

FIG. 12 is an exploded view of the floating candle according to the second embodiment of the present invention;

FIG. 13 is a perspective view of a floating part in the floating candle according to the second embodiment of the present invention;

FIG. 14 is a plan view of the floating part in the floating candle according to the second embodiment of the present invention;

FIG. 15 is an exploded view of the floating part in the floating candle according to the second embodiment of the present invention;

FIG. 16 is a perspective view of a wick reception part in the floating candle according to the second embodiment of the present invention;

FIG. 17 is a plan view of the wick reception part in the floating candle according to the second embodiment of the present invention;

FIG. 18 is a bottom perspective view of the wick reception part in the floating candle according to the second embodiment of the present invention;

FIGS. 19 and 20 are perspective views of the wick support part in the floating candle according to the second embodiment of the present invention;

FIGS. 21 to 24 are views showing the state of use of the floating candle according to the present invention;

FIG. 25 is a perspective view of the floating part of a floating candle according to a third embodiment of the present invention;

FIG. 26 is an exploded perspective view of the floating part of a floating candle according to a fourth embodiment of the present invention;

FIGS. 27 to 29 are views showing a floating candle according to a fifth embodiment of the present invention; and

FIG. 30 is a perspective view of still another embodiment of the wick reception part of the floating candle according to the present invention.

### BEST MODE

The terms or words used in the present specification and the attached claims should not be interpreted as being limited to common or dictionary meanings, but should be interpreted as having meanings and concepts suitable for the technical spirit of the invention based on the principle that an inventor may appropriately define the concepts of terms in order to describe his or her invention in the best way. Accordingly, the embodiments described in present specification and the configurations shown in the drawings are merely the most preferred embodiments of the invention and do not represent the overall technical spirit of the invention, so that it should be understood that there may be various equivalents and modifications that can replace the embodiments at the time when the present application is filed. Furthermore, a detailed description of a well-known function or configuration that may unnecessarily make the gist of the present invention obscure will be omitted. Preferred embodiments of the present invention will be described in detail below with reference to the accompanying drawings.

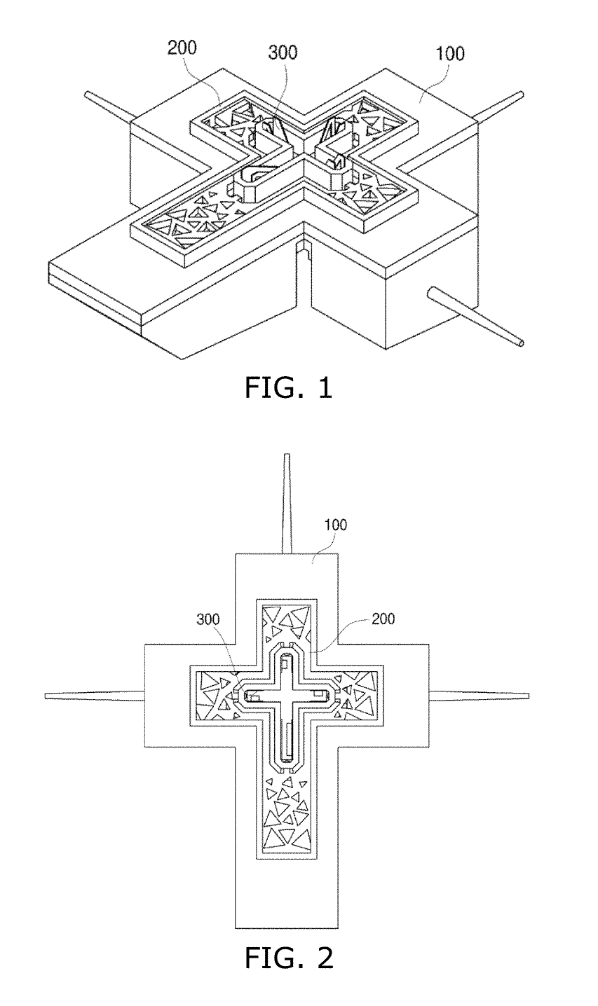

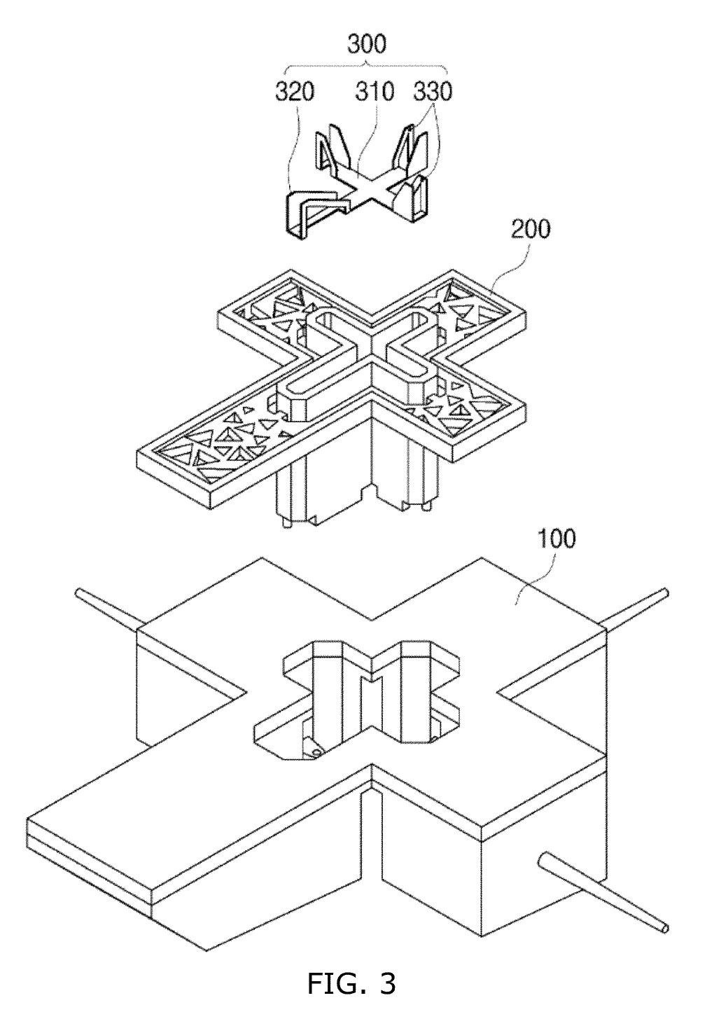

FIG. 1 is a perspective view of a floating candle according to a first embodiment of the present invention, FIG. 2 is a plan view of the floating candle according to the first embodiment of the present invention, and FIG. 3 is an exploded view of the floating candle according to the first embodiment of the present invention.

Referring to FIGS. 1 to 3, the floating candle according to the first embodiment of the present invention includes: a floating part 100 configured to float on combustible material W; a wick reception part 200 configured such that one side thereof passes through the floating part 100 and comes into contact with the combustible material W and the other side thereof comes into contact with the top surface of the floating part 100; and a wick support part 300 configured to be mounted to the bottom end of a wick S, to be inserted into the wick reception part 200, and to support the wick S.

In the floating candle according to the first embodiment of the present invention, when the wick S is lit, the wick support part 300 and the wick reception part 200 (more specifically, a conduction part 230 to be described later) are sequentially heated by heat, and the combustible material W in contact with the wick reception part 200 (more specifically, the conduction part 230 to be described later) is melted. Accordingly, the combustible material W comes into contact with the bottom end of the wick S inserted into the wick reception part 200, and the melted combustible material W is sucked up to the top end of the wick S due to a capillary phenomenon and is continuously burned at the top end of the wick S. In this case, although the combustible material W may be combustible material, such as wax including paraffin, or the like, that is solid at normal temperature and liquefied upon heating, it is not necessarily limited thereto, but may be liquid-state combustible material, such as oil or the like.

At the same time, the floating part 100 floats on the melted combustible material W, and thus the floating candle lights continuously while floating on the combustible material W. In this case, the floating part 100, the wick reception part 200, and the wick support part 300 are disposed between the wick S and the combustible material W, thereby preventing the wick and the combustible material from directly coming into contact with each other even when the wick floats on the combustible material. Accordingly, the risk of a fire attributable to the burning of wax itself can be reduced by applying the present invention.

Furthermore, the shape of the floating part 100 and the shapes of the wick reception part and an ornamentation part located inside the floating part may be formed in various manners. The floating candle according to the present invention can move while floating on the combustible material, and can thus produce a new aesthetic to a viewer.

Detailed descriptions of the floating part 100, the wick reception part 200, and the wick support part 300 will be given later.

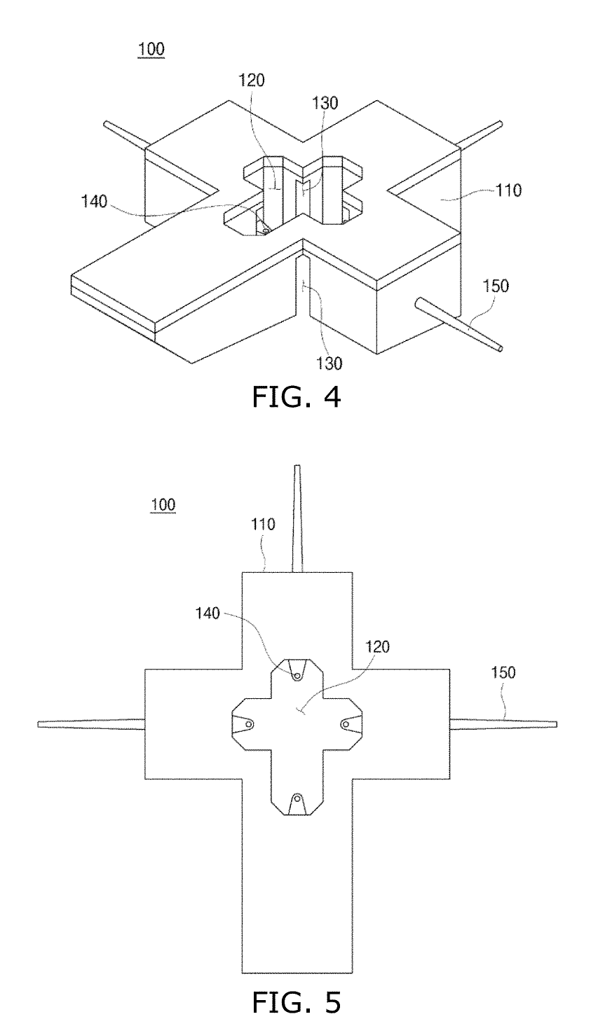

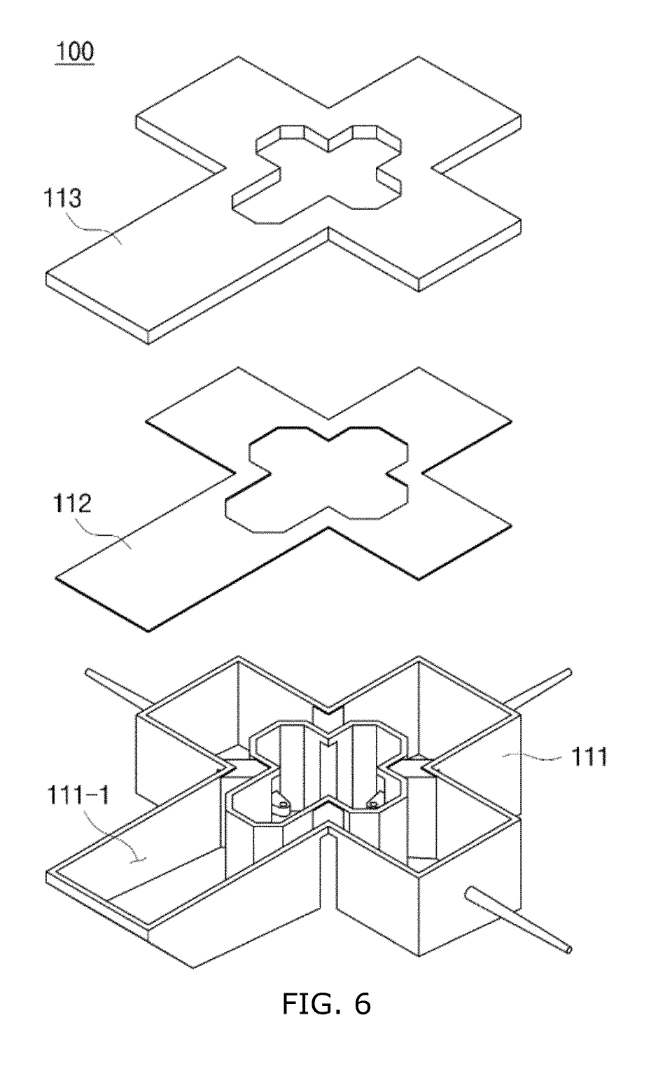

FIG. 4 is a perspective view of the floating part in the floating candle according to the first embodiment of the present invention, FIG. 5 is a plan view of the floating part in the floating candle according to the first embodiment of the present invention, and FIG. 6 is an exploded view of the floating part in the floating candle according to the first embodiment of the present invention. Referring to FIGS. 4 to 6, the floating part 100 of the floating candle according to the first embodiment of the present invention includes a floating part body 110, a first through hole 120, combustible material flow paths 130, support portions 140, and protruding portions 150.

A space 111-1 is formed inside the floating part body 110. Accordingly, the floating part 100 can float on the melted combustible material W. A detailed description of the floating part body 110 will be given below.

The first through hole 120 is formed from the top surface of the floating part body 110 to the bottom surface of the floating part body 110 so that the wick reception part 200 can be inserted thereinto. In this case, although the shape of the first through hole 120 may be a cross shape (in the first embodiment) or heart shape (in a second embodiment), it is not necessarily limited thereto, but may be one of various shapes according to a designer's intention or an aesthetic to be produced.

The combustible material flow paths 130 are formed in the lower portion of the floating part body 110 in order to make the outside of the floating part body 110 communicate with the first through hole 120. In other words, as described above, the floating candle according to the present invention floats on the melted liquid-state combustible material W. In this case, there is concern that the temperature of the floating part body 110 in contact with the melted combustible material W rises continuously, and thus there is a concern that thermal damage is caused or, in the worst case, the floating part body 110 is melted down. In greater detail, the wick support part 300 and the wick reception part 200 are heated by the flames of the wick S (due to thermal conduction), and accordingly the combustible material W is melted and heated. When the high-temperature combustible material W heated as described above comes into continuous contact with the bottom end of the floating part body 110, the temperature of the floating part body 110 rises and thus thermal damage is caused.

In order to prevent the above problem, in the present invention, the combustible material flow paths 130 are formed in the lower portion of the floating part body 110, and the high-temperature combustible material W is continuously discharged from the lower portion of the floating part body 110 to the outside of the floating part body 110. In other words, the floating part body 110, more specifically the inside surface of the floating part body 110 forming the first through hole 120, is prevented from being thermally damaged by using the convection phenomenon of the combustible material W.

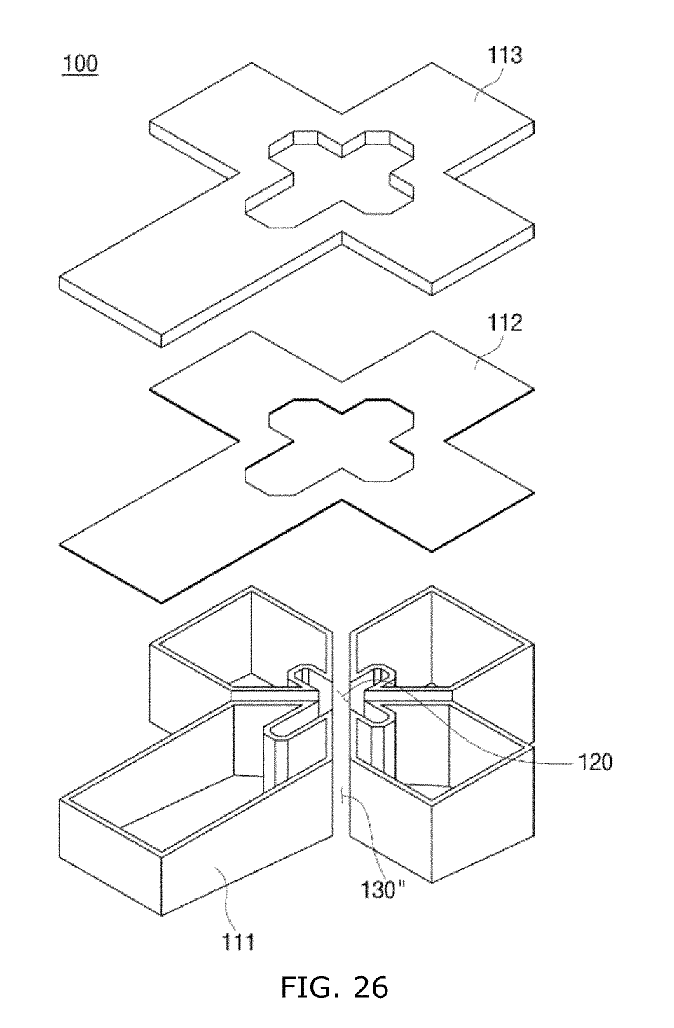

Furthermore, in still another embodiment (a third embodiment) of the present invention, combustible material flow paths 130′ may be formed in the top end of the floating part body 110 (see FIG. 25). In greater detail, the conduction part 230 may be disposed inside the first through hole 120, and connection pins 114 configured to connect the conduction part 230 and the floating part body 110 may be further included.

Accordingly, the combustible material flow paths 130′ formed at the top end of the floating part body 110 and the first through hole 120 communicate with each other, and the melted high-temperature combustible material W introduced into the floating part body 110 through the first through hole 120 is discharged through the combustible material flow paths 130,' thereby preventing the floating part body 110 from being thermally damaged.

In the floating candle of the third embodiment, there occurs submergence in the melted combustible material W to a predetermined or higher depth, and thus mobility on the melted combustible material W is low. Accordingly, to prevent the floating part body 110 from being thermally damaged, the material of the floating part body 110 is preferably material having high thermal resistance.

In still another embodiment (a fourth embodiment) of the present invention, the height of combustible material flow paths 130″ may be formed to be equal to that of a first through hole 120 (see FIG. 26). In other words, the area of the combustible material flow paths 130″ is maximized, and thus the melted high-temperature combustible material W introduced into the floating part body 110 is discharged through the combustible material flow paths 130″ as fast as possible. Accordingly, material having relatively low thermal resistance can be used as the material of the floating part body 110, and thus the manufacturing cost of the floating candle according to the fourth embodiment can be reduced.

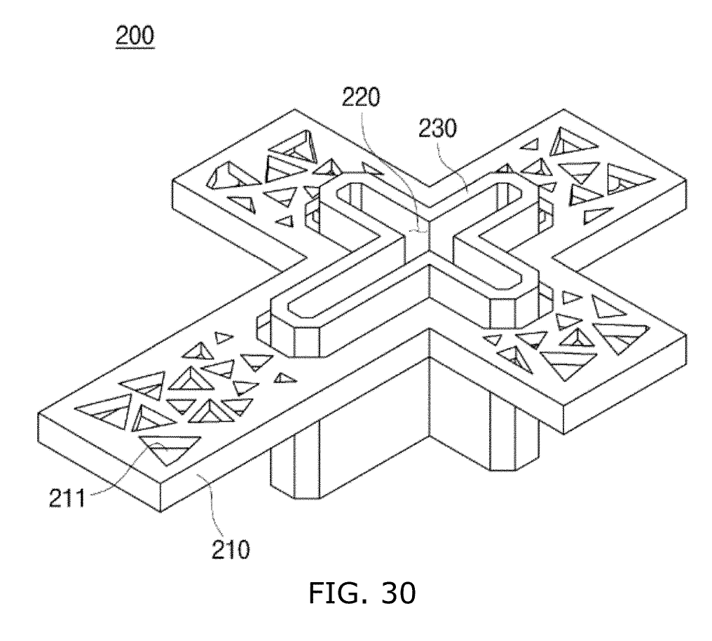

The support portions 140 protrude from the inside surface of the first through hole 120, and function to support the bottom end of the wick reception part 200. In other words, the support protrusions 240 of the wick reception part 200 to be described later are inserted into the support portions 140, and thus the floating part body 100 and the wick reception part 200 are engaged with each other. However, the support portions 140 and the support protrusions 240 may be omitted, in which case the wick reception part 200 is supported on the top of a floating part 100 by an upper plate 210 (see FIG. 30). A detailed description thereof will be given later.

The protruding portions 150 protrude from the side surfaces of the floating part body 110. The inner circumferential surface of a container for the combustible material W and the floating part body 110 can be prevented from directly colliding with each other by the protruding portions 150. In other words, as described above, the floating part body 110 floats on the combustible material W, and thus the floating candle according to the present invention can move freely within the container for the combustible material W. However, when the floating part body 110 and the container for the combustible material W directly collide with each other, there is concern that the floating candle according to the present invention is overturned and a large fire breaks out, and thus there is a need to prevent this risk.

For this purpose, the protruding portions 150 are added to the side surfaces of the floating part body 110, and thus the floating part body 110 and the container for the combustible material W are prevented from directly colliding with each other, thereby preventing the risk of a fire attributing the overturn of the floating candle.

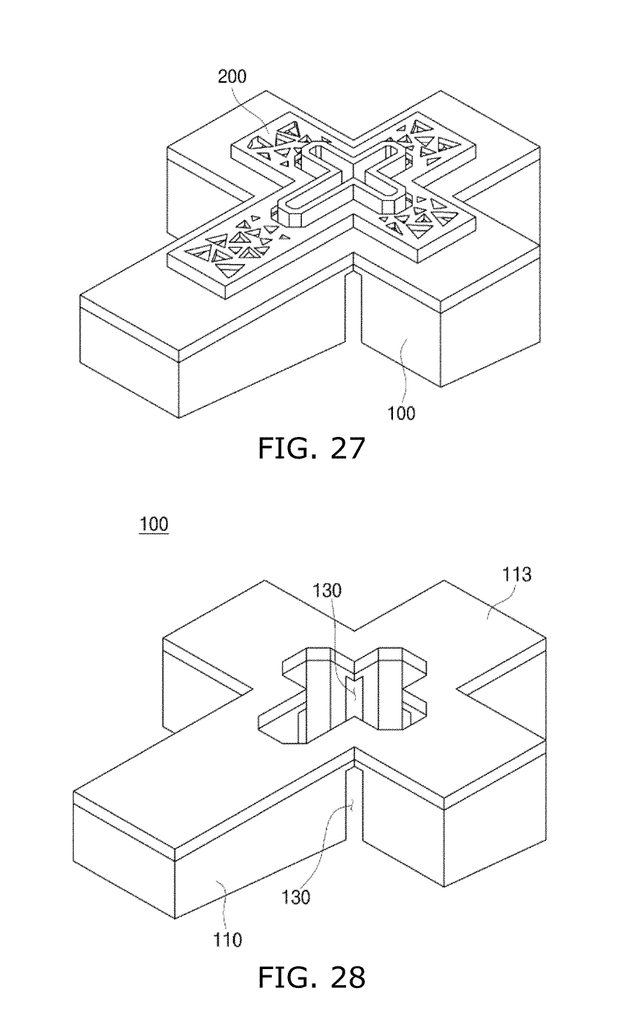

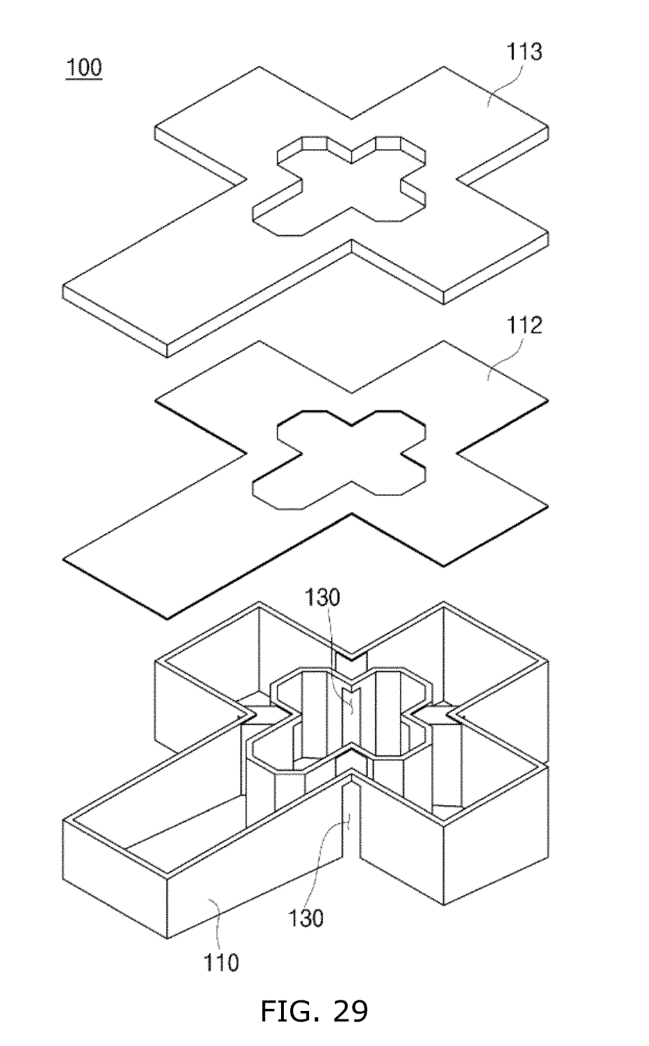

However, in still another embodiment (a fifth embodiment) of the present invention, the protruding portions 150 may be omitted (see FIGS. 27 to 29). The fifth embodiment is applicable to a case where the area of the container for the combustible material W is relatively small. In other words, when the floating movement of the floating candle according to the fifth embodiment is relatively little, the risk of a fire attributing the overturn of the floating candle is reduced. When the area of the container for the combustible material W is relatively small, the protruding portions 150 may rather act as an obstruction factor. Accordingly, in the fifth embodiment, the protruding portions 150 may be omitted, unlike in the first embodiment.

The floating part body 110 will be described in detail below. The floating part body 110 includes a space formation part 111, a cover part 113, and an ornamentation part 112 (see FIG. 6).

The space 111-1 is formed inside the space formation part 111, and is a component below which the combustible material flow paths 130 are formed. Although the space 111-1 may be open upward, it is not necessarily limited thereto, but has a closed state.

The cover part 113 is coupled to the top surface of the space formation part 111. In this case, the space formation part 111 and the cover part 113 may be sealed and integrated with each other. As described above, the floating part body 110 floats on the melted fuel material W. For this purpose, it is necessary to secure buoyancy. Accordingly, as described above, the space 111-1 is formed inside the space formation part 111, and the space formation part 111 and the cover part 113 are sealed in order to prevent the melted fuel material W from infiltrating into the space 111-1.

Furthermore, the ornamentation part 112 is disposed between the space formation part 111 and the cover part 113, and is inserted between the space formation part 111 and the cover part 113 before the space formation part 111 and the cover part 113 are sealed. The ornamentation part 112 is a component configured to maximize the aesthetic of the floating candle, and the ornamentation part 112 may be paper on which various ornamental shapes have been printed. However, the ornamentation part 112 is not necessarily limited thereto, and may be formed in various manners according to a designer's intention. Furthermore, an ornament, such as a dry flower petal or the like, as well as the ornamentation part 112, may be disposed inside the space

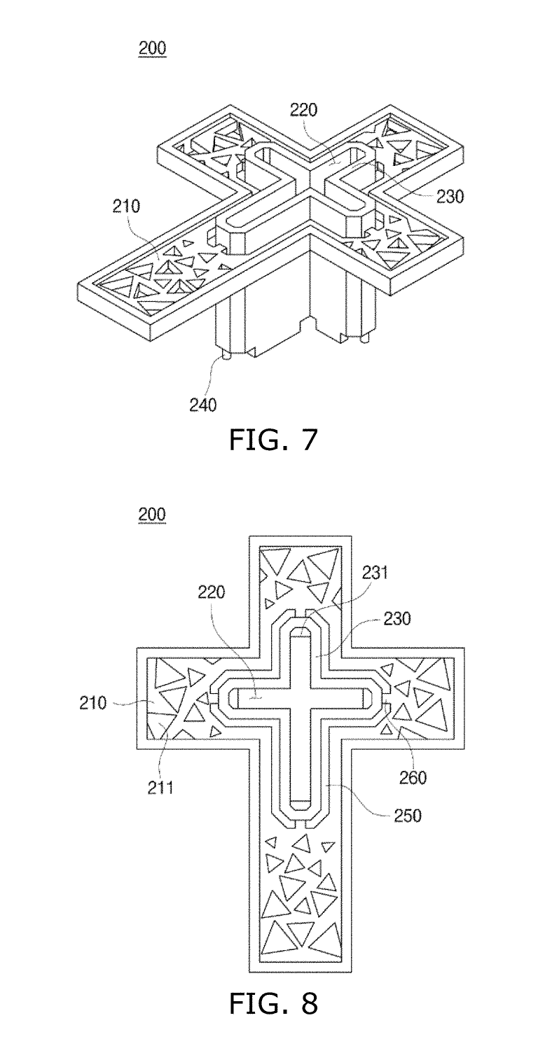

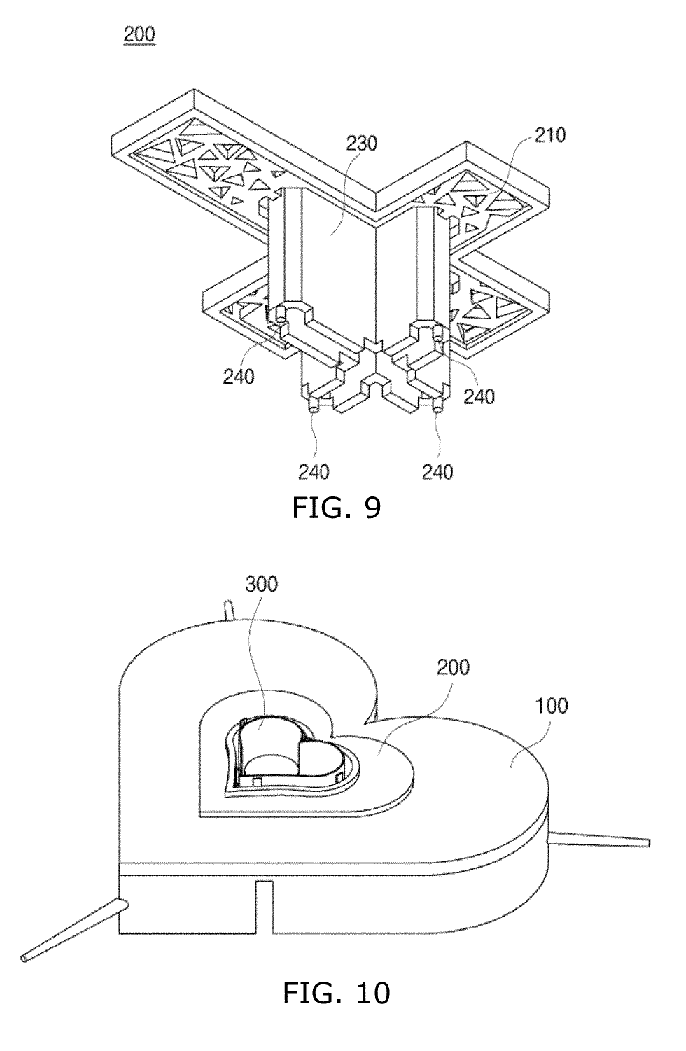

FIG. 7 is a perspective view of the wick reception part in the floating candle according to the first embodiment of the present invention, FIG. 8 is a plan view of the wick reception part in the floating candle according to the first embodiment of the present invention, and FIG. 9 is a bottom perspective view of the wick reception part in the floating candle according to the first embodiment of the present invention.

The wick reception part 200 includes an upper plate 210, a second through hole 220, a conduction part 230, and support protrusions 240. The upper plate 210 may be disposed in contact with the top surface of the floating part 100, and ornamental holes 211 may be formed in the upper plate 210 in a vertical direction. The shape of the ornamental holes 211 may be formed in various manners, and it is sufficient if the shape of the ornamental holes 211 produces an aesthetic.

The second through hole 220 is formed from the top surface of the upper plate 210 to the bottom surface thereof, and the conduction part 230 is extended upward or downward from the inner circumferential surface of the second through hole 220. The wick support part 300 and the wick S are inserted into the conduction part 230, and the conduction part 230 conducts the heat, transferred by the flame of the wick S, to the combustible material W, thereby enabling the combustible material W to be rapidly melted. The reason for this is to rapidly melt the combustible material W so that the combustible material W can move along a wick and enters into the state of being easy to burn.

The support protrusions 240 protrude from the upper plate 210 or conduction part 230. The support protrusions 240 comes into contact with the support portions 140, and functions to support the bottom end of the wick reception part 200. Furthermore, the support protrusions 240 are press-fitted into the support portions 140, and thus the floating part body 100 and the wick reception part 200 can be engaged with each other.

However, the support portions 140 and the support protrusions 240 may be omitted, in which case the wick reception part 200 is supported on the top of the floating part 100 by the upper plate 210 (see FIG. 30). In other words, the method of engaging the wick reception part 200 and the floating part 100 with each other may be modified in various manners. There may be applied a method of placing the wick reception part 200 on the floating part 100 without engaging the wick reception part 200 and the floating part 100 with each other.

The wick reception part 200 according to the first embodiment of the present invention is characterized by further including gaps 250 and connection portions 260. The gaps 250 are formed so that the upper plate 210 and the conduction part 230 are spaced apart from each other by a predetermined interval. The connection portions 260 traverse the gaps 250, and function to connect the upper plate 210 and the conduction part 230 to each other.

In other words, as described above, the conduction part 230 receives heat from the flames of the wick S, and rapidly enters into a high-temperature state. Accordingly, the upper plate 210 connected to the conduction part 230 can also receive heat, and thus the temperature of the upper plate 210 can rise. In this case, the top surface of the floating part body 110 is also heated by the upper plate 210, and thus there is significant concern that the top surface (i.e., the cover part 113) of the floating part body 110 is thermally damaged.

In order to prevent this problem, in the first embodiment of the present invention, the gaps 250 and the connection portions 260 are formed, thereby minimizing the transfer of the heat of the conduction part 230 to the upper plate 210.

Furthermore, stop plates 231 protrude inward from the inner circumferential surface of the conduction part 230. Accordingly, the bottom end of the wick support part 300 is supported on the top surfaces of the stop plates 231, and the stop plates 231 function to prevent the wick support part 300 from passing through the second through hole 220 and sinking into the melted combustible material W.

Furthermore, in the first embodiment of the present invention, the wick support part 300 includes a wick support part bottom surface 310 and wick support part side surfaces 320 (see FIG. 3). The wick support part bottom surface 310 supports the bottom surface of the wick S, and is formed in the same shape as the second through hole 220. The reason for this is that the wick support part 300 needs to be inserted into the second through hole 220.

The wick support part side surfaces 320 are extended from both sides of the wick support part bottom surface 310, and function to support the side surfaces of the wick S.

Furthermore, first fastening protrusions 330 protrude from the wick support part side surfaces 320, and function to fasten the wick S. In other words, the first fastening protrusions 330 prevent the wick S from being separated from the wick support part 300.

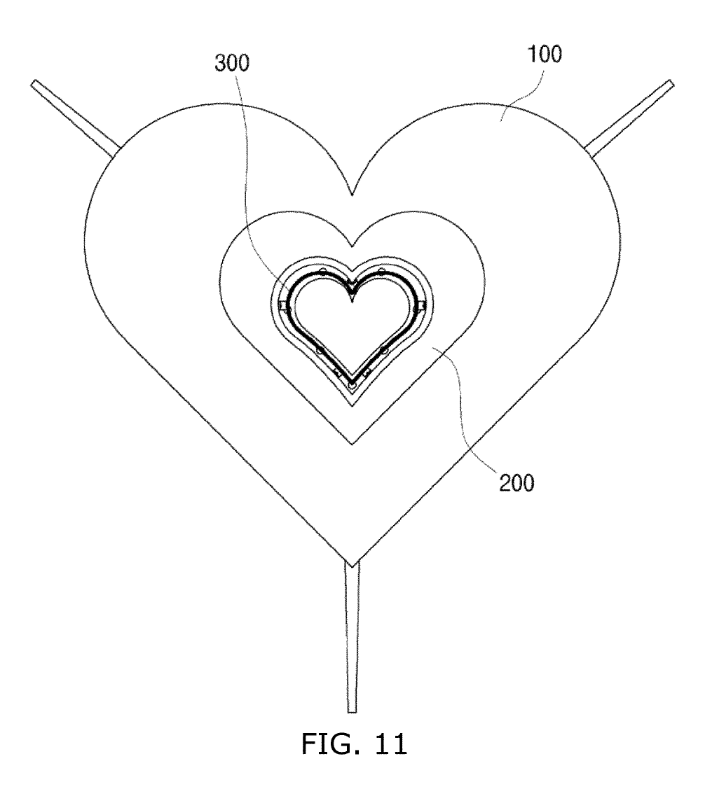

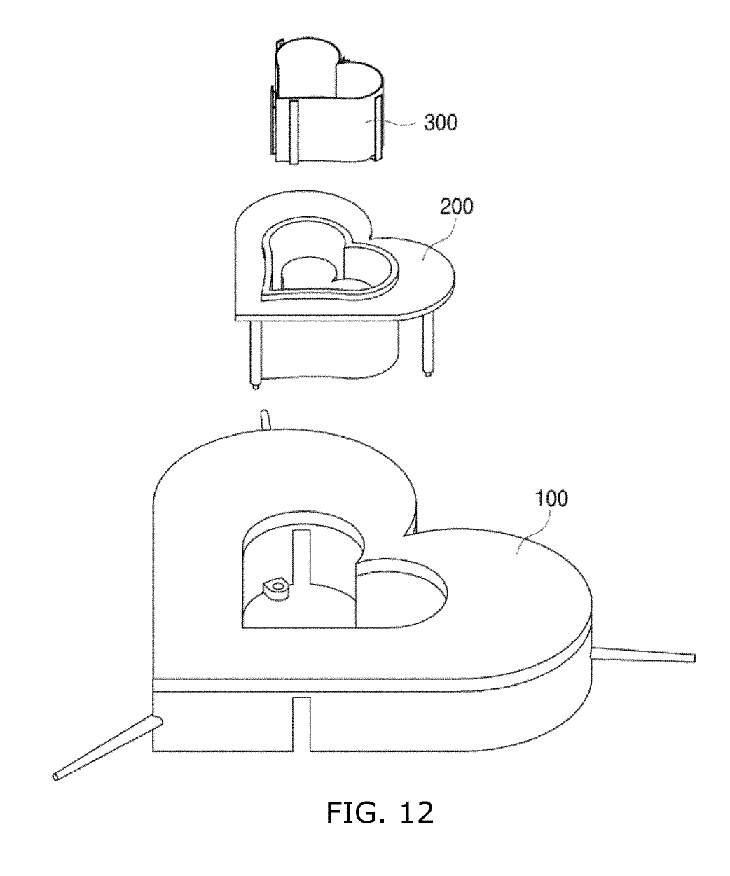

FIG. 10 is a perspective view of the floating candle according to the second embodiment of the present invention, FIG. 11 is a plan view of the floating candle according to the second embodiment of the present invention, and FIG. 12 is an exploded view of the floating candle according to the second embodiment of the present invention.

Referring to FIGS. 10 to 12, the floating candle according to the second embodiment of the present invention and the floating candle according to the first embodiment of the present invention are different from each other only in their shape (a cross shape versus a heart shape), and are almost the same in their configuration. Accordingly, as for the floating candle according to the second embodiment of the present invention, detailed descriptions that are the same as those of the floating candle according to the first embodiment of the present invention will be omitted, and only detailed descriptions will be given with a focus on the differences. The second embodiment of the present invention includes a floating part 100, a wick reception part 200, and a wick support part 300 like the first embodiment. Detailed descriptions of the floating part 100, the wick reception part 200, and the wick support part 300 are the same as described above.

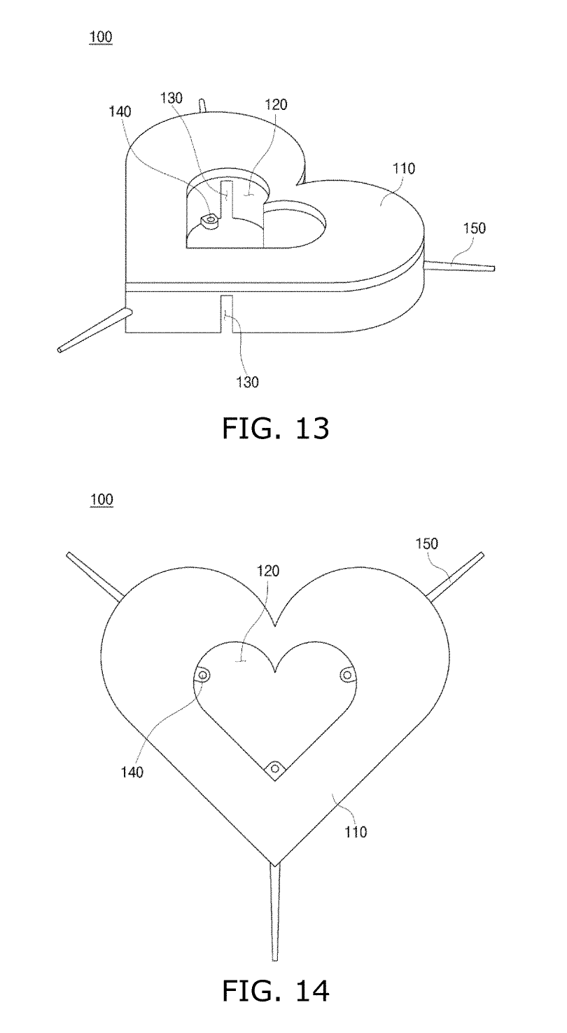

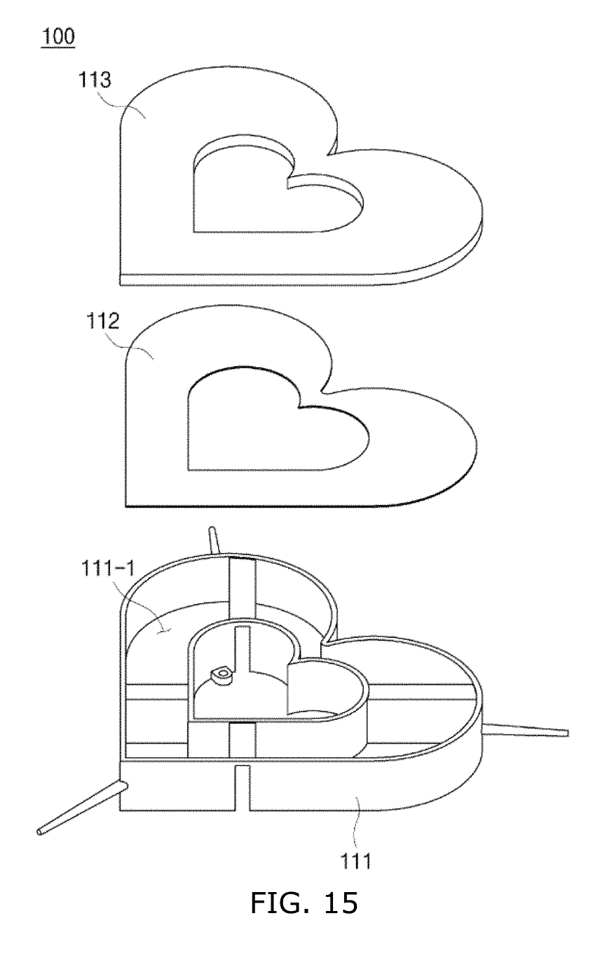

FIG. 13 is a perspective view of the floating part in the floating candle according to the second embodiment of the present invention, FIG. 14 is a plan view of the floating part in the floating candle according to the second embodiment of the present invention, and FIG. 15 is an exploded view of the floating part in the floating candle according to the second embodiment of the present invention.

Referring to FIGS. 13 to 15, the floating part of the floating candle according to the second embodiment of the present invention and the floating part of the floating candle according to the first embodiment of the present invention are different from each other only in their shape (a cross shape versus a heart shape), and are the same as each other in their configuration. Accordingly, a further detailed description of the floating part of the floating candle according to the second embodiment of the present invention will be omitted.

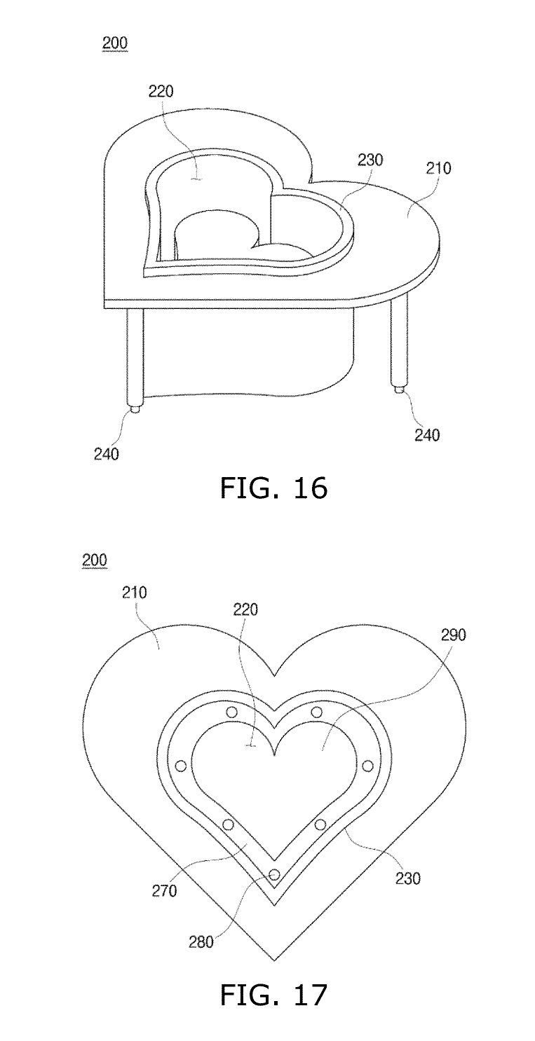

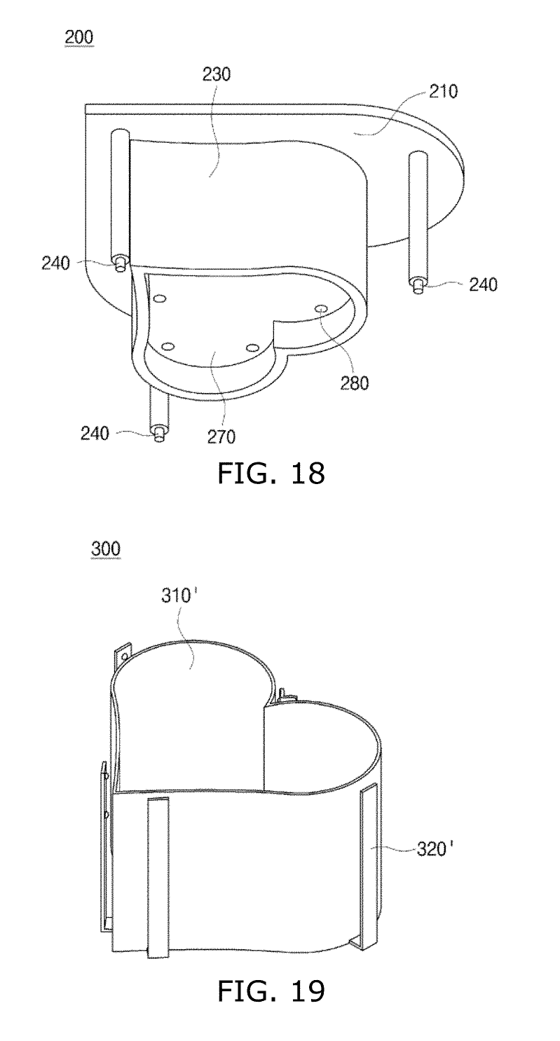

FIG. 16 is a perspective view of the wick reception part in the floating candle according to the second embodiment of the present invention, FIG. 17 is a plan view of the wick reception part in the floating candle according to the second embodiment of the present invention, and FIG. 18 is a bottom perspective view of the wick reception part in the floating candle according to the second embodiment of the present invention.

Referring to FIGS. 16 to 18, the wick reception part 200 also includes an upper plate 210, a second through hole 220, a conduction part 230, and support protrusions 240. In particular, the wick reception part 200 of the floating candle according to the second embodiment of the present invention is characterized by further including a closing part 270, third through holes 280, and a second conduction part 290.

The closing part 270 protrudes from the inner circumferential surface of the conduction part 230 in order to close the second through hole 220. The third through holes 280 pass through the closing part 270 in a vertical direction so that the combustible material W can come into contact with the wick. Furthermore, the second conduction part 290 is spaced apart from the surface inner circumferential of the conduction part 230 by a predetermined distance, and protrudes upward from the closing part 270.

In other words, in the above-described first embodiment, the section of the wick S is formed in a shape (a cross shape) other than a closed curve, and thus the wick S can be supported on both sides. In contrast with this, in the second embodiment of the present invention, the section of the wick S is a single closed curve shape (a heart shape), and thus a separate configuration for stably supporting the wick S on the inside and outside of the wick S is required.

Accordingly, the conduction part 230 supports the outside of the wick S, the closing part 270 supports the bottom of the wick S, and the second conduction part 290 supports the inside of the wick S, thereby enabling the wick S to be stably supported. Furthermore, the third through holes 280 are formed in the closing part 270, and thus the melted combustible material W can easily come into contact with the bottom end of the wick S through the third through holes 280.

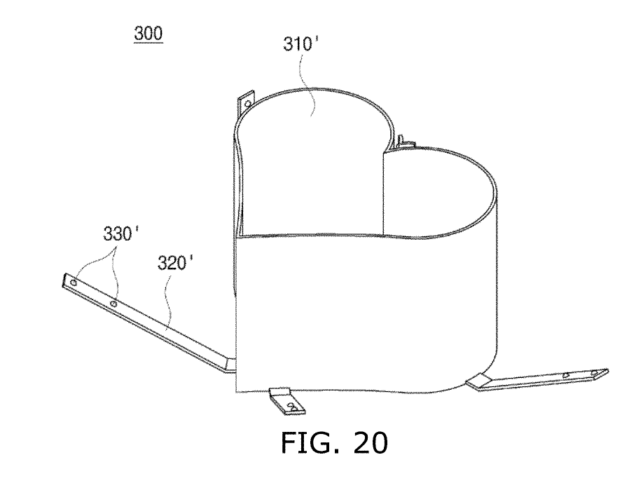

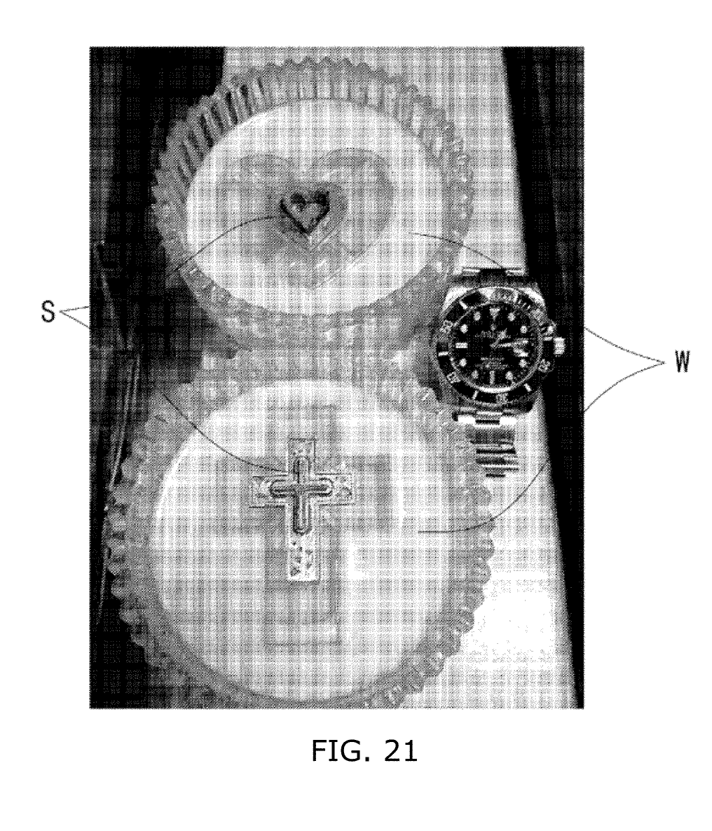

FIGS. 19 and 20 are perspective views of the wick support part in the floating candle according to the second embodiment of the present invention. Referring to FIGS. 19 and 20, the wick support part 300 includes a third conduction part 310,′ wick fastening parts 320,′ and second fastening protrusions 330.′

The third conduction part 310′ is formed to come into contact with the outside surface of the second conduction part 290. The wick fastening parts 320′ are each formed such that one end is fastened to the bottom end of the third conduction part 310′ and the other end thereof is parallel to the side surface of the third conduction part 310.′

Accordingly, when the wick S is mounted on the wick support part 300, the wick fastening parts 320′ are deformed first such that the wick fastening parts 320′ are spaced apart from the third conduction part 310.′ Thereafter, the inside surface of the wick S is brought into contact with the third conduction part 310,′ and the wick fastening parts 320′ are restored to their original positions.

In this case, the second fastening protrusions 330′ protruding from the wick fastening parts 320′ to the third conduction part 310′ bring the wick S into complete, tight contact with the third conduction part 310,′ thereby enabling the wick S to be stably mounted on the wick support part 300.

FIGS. 21 to 24 are views showing the state of use of the floating candle according to the present invention. The state of use of the floating candle according to the present invention will be described below with reference to FIGS. 21 to 24.

FIG. 21 shows an initial state, in which the combustible material W is solidified inside a container. Furthermore, the floating candle according to the present invention is disposed on the combustible material W, and the wick S is in a state in which it is not lit yet.

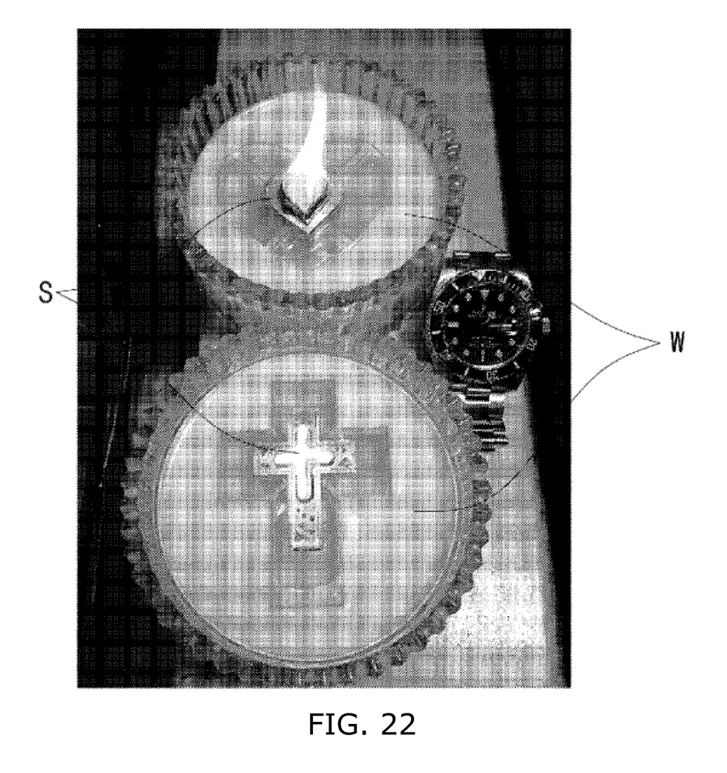

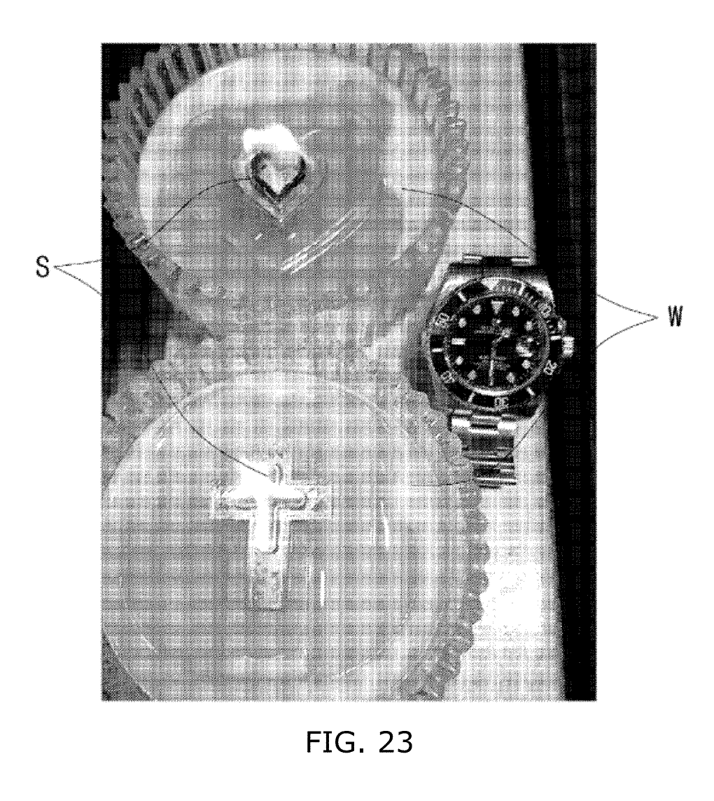

FIG. 22 shows a state in which the wick S has been lit, in which the heat of flames starts to be transferred to the combustible material W through the wick support part 300 and the conduction part 230 of the wick reception part 200, as described above.

FIG. 23 shows a state in which predetermined time has elapsed after the wick S was lit, in which the combustible material W near the conduction part 230 starts to be melt and a melted area increases gradually. However, there is a portion that is not melted yet, and thus a state in which the floating candle can move freely is not reached.

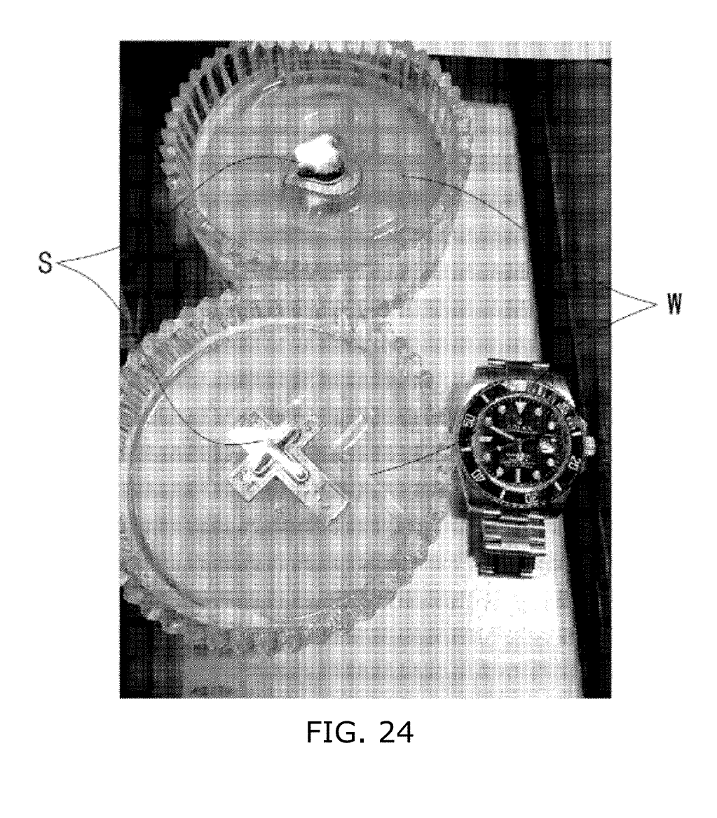

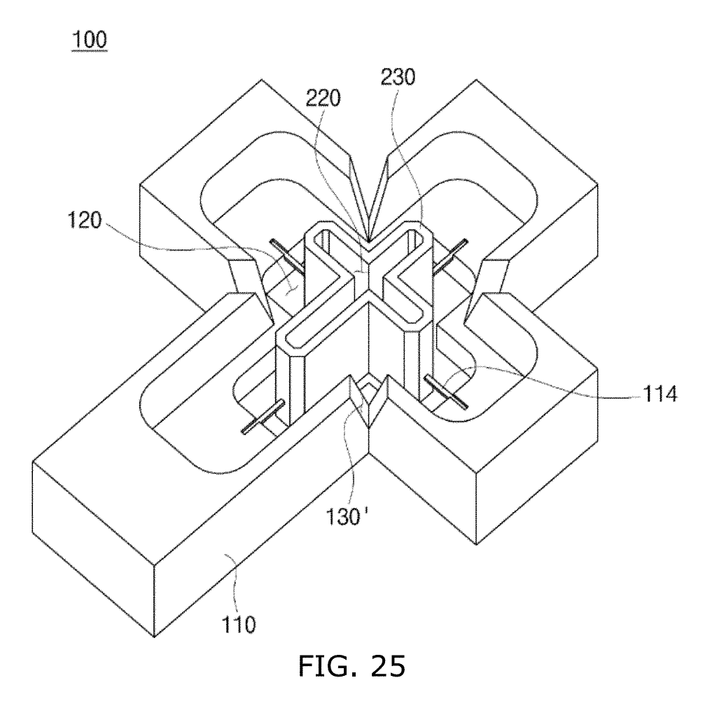

FIG. 24 shows a state in which most of the combustible material W has been melted finally. Accordingly, the floating candle can move freely, and thus a new aesthetic can be produced.

The above-described embodiments are merely preferred embodiments that enable those having ordinary knowledge in the art to which the present invention pertains (hereinafter referred to as “those skilled in the art”) to easily practice the present invention. Since the present invention is not limited to the above-described embodiments and the accompanying drawings, the scope of the present invention is not limited by the embodiments. Therefore, it will be apparent to those skilled in the art that various substitutions, modifications, and alterations are possible without departing from the technical spirit of the present invention. Furthermore, it will be apparent that the portions that can be easily modified by those skilled in the art fall within the scope of the present invention.

### DESCRIPTION OF REFERENCE SYMBOLS

100 floating part

110 floating part body

111 space formation part

111-1 space

112 ornamentation part

113 cover part

114 connection pin

120 first through hole

130, 130′, 130″ combustible material flow path

140 support portion

150 protruding portion

200 wick reception part

210 upper plate

211 ornamental hole

220 second through hole

230 conduction part

231 stop plate

240 support protrusion

250 gap

260 connection portion

270 closing part

280 third through hole

290 second conduction part

300 wick support part

310 wick support part bottom surface

320 wick support part side surface

330 first fastening protrusion

310′ third conduction part

320′ wick fastening part

330′ second fastening protrusion

W combustible material

S wick

1. A floating candle comprising:
a floating part (100) configured to float on combustible material (W);
a wick reception part (200) configured such that one side thereof passes through the floating part (100) and comes into contact with the combustible material (W) and a remaining side thereof comes into contact with a top surface of the floating part (100); and
a wick support part (300) configured to be mounted at a bottom end of a wick (S), to be inserted into the wick reception part (200), and to support the wick (S).

2. The floating candle of claim 1, wherein the floating part (100) comprises:
a floating part body (110) configured such that a space (111-1) is formed therein;
a first through hole (120) formed from a top surface of the floating part body 110 to a bottom surface thereof so that the wick reception part (200) can be inserted thereinto;
combustible material flow paths (130) formed in a lower portion of the floating part body (110) in order to make an outside of the floating part body (110) and the first through hole (120) communicate with each other;
support portions (140) configured to protrude from an inside surface of the first through hole (120) and to support a bottom end of the wick reception part (200); and
protruding portions (150) configured to protrude from side surfaces of the floating part body (110).

3. The floating candle of claim 2, wherein the floating part body (110) comprises:
a space formation part (111) configured such that the space 111-1 is formed therein and the combustible material flow paths (130) are formed in a lower portion thereof; and
a cover part (113) configured to be coupled to a top surface of the space formation part (111).

4. The floating candle of claim 3, wherein the space formation part (111) and the cover part (113) are sealed and integrated with each other.

5. The floating candle of claim 3, wherein the floating part body (110) further comprises:
an ornamentation part (112) configured to be disposed between the space formation part (111) and the cover part (113).

6. The floating candle of claim 2, wherein the wick reception part (200) comprises:
an upper plate (210) configured to come into contact with a top surface of the floating part (100);
a second through hole (220) formed from a top surface of the upper plate (210) to a bottom surface thereof;
a conduction part (230) extended upward or downward from an inner circumferential surface of the second through hole (220); and
support protrusions (240) configured to protrude from the upper plate (210) or conduction part (230), to come into contact with the support portions (140), and to support a bottom end of the wick reception part (200).

7. The floating candle of claim 6, wherein the wick reception part (200) comprises:
gaps (250) formed to space the upper plate (210) and the conduction part (230) apart from each other by a predetermined interval;
connection portions (260) configured to traverse the gaps (250) and connect the upper plate (210) and the conduction part (230) to each other; and
stop plates (231) configured to protrude inward from an inner circumferential surface of the conduction part (230).

8. The floating candle of claim 6, wherein the upper plate (210) comprises:
ornamental holes (211) formed in a vertical direction.

9. The floating candle of claim 6, wherein the wick support part (300) comprises:
a wick support part bottom surface (310) configured to support a bottom surface of the wick (S), and formed in a shape identical to that of the second through hole (220);
wick support part side surfaces (320) extended from both sides of the wick support part bottom surface (310), and configured to support side surfaces of the wick (S); and
first fastening protrusions 330 configured to protrude from the wick support part side surface (320), and to fasten the wick (S).

10. The floating candle of claim 6, wherein the wick reception part (200) comprises:
a closing part (270) configured to protrude from an inner circumferential surface of the conduction part (230) in order to close the second through hole (220); and
third through holes (280) configured to pass through the closing part (270) in a vertical direction in order to allow the combustible material (W) to come into contact with the wick.

11. The floating candle of claim 10, wherein the wick reception part (200) further comprises:
a second conduction part (290) formed to be spaced apart from the inner circumferential surface of the conduction part (230) by a predetermined distance, and to protrude upward from the closing part (270).

12. The floating candle of claim 11, wherein the wick support part (300) comprises:
a third conduction part (310′) formed to come into contact with an outside surface of the second conduction part (290); and
wick fastening parts (320′) each configured such that one end thereof is fastened to a bottom end of the third conduction part (310′) and a remaining end thereof is formed to be parallel to a side surface of the third conduction part (310′).

13. The floating candle of claim 12, wherein the wick support part (300) further comprises:
second fastening protrusions (330′) formed to protrude from the wick fastening parts (320′) toward the third conduction part (310′).
